(19) United States
(12) Patent Application Publication
(10) Pub. No.: US 2017/0065479 A1
(43) Pub. Date: Mar. 9, 2017

(54) ADJUSTABLE WHEEL SUSPENSION ASSEMBLY FOR A WHEELED WALKER

(71) Applicants: Peter James Fellingham, San Diego, CA (US); Yichuan Pan, San Diego, CA (US)

(72) Inventors: Peter James Fellingham, San Diego, CA (US); Yichuan Pan, San Diego, CA (US)

(73) Assignee: Protostar, Inc., a Delaware Corporation, San Diego, CA (US)

(21) Appl. No.: 15/012,784

(22) Filed: Feb. 1, 2016

Related U.S. Application Data
(60) Provisional application No. 62/215,656, filed on Sep. 8, 2015.

(51) Int. Cl. A61H 3/04; B60G 17/02; B60G 11/14; B60G 3/14; B60G 7/00

(52) U.S. Cl. CPC A61H 3/04; B60G 3/145; B60G 7/001; B60G 11/14; B60G 17/021; B60G 2200/13; B60G 2202/12

(57) ABSTRACT

An adjustable wheel suspension assembly for a wheeled walker providing both lateral and longitudinal stability under load. With a calibrated spring preload adjustment, the wheel suspension assembly provides lateral stability for any particular user body weight and a wheel deflection working stroke sufficient to absorb wheel shocks over irregular terrain. The wheel suspension assembly is particularly advantageous for upright wheeled walkers.

### CROSS-REFERENCES TO RELATED APPLICATIONS

This application is filed under 35 U.S.C. 111(a) pursuant to 37 C.F.R. 1.53(b) and claims the benefit under 35 U.S.C. §119(e) of U.S. Patent Application No. 62/215,656 filed on Sep. 8, 2015 and entirely incorporated herein by reference.

### BACKGROUND OF THE INVENTION

1. Field of the Invention:

This invention relates generally to a wheel suspension assembly for wheeled mobility-assistance devices and more particularly to an adjustable wheel suspension for wheeled walkers

2. Description of the Related Art

The wheeled walker (also denominated rollator) is well-known in the art as an improvement to the earlier walker and cane mobility aids and is a popular mobility assistance vehicle for the mobility impaired. The advantages of the wheeled walker are known to include smother and more comfortable movement along even surfaces without obliging the user to lift or slide the aid along. But adding wheels to the mobility aid introduces the new disadvantages of instability and user safety. For example, in U.S. Pat. No. 8,936,033, Velarde suggests adding wheels to only two of the four walker supports to ease movement while controlling instability.

Many practitioners suggest further improvements to mitigate these added disadvantages. For example, in U.S. Pat. No. 4,907,794, Rose discloses a foldable rolling walker having a high crossbar for easier walking convenience, height adjustable handles centered over offset wheels for greater stability, lockable pivoting front wheels and reversible brakes. Other similar improvements made to wheeled walkers include folding mechanisms, user-controlled wheel brakes and larger wheel sizes to improve stability and user safety. For example, in U.S. Pat. No. 7,001,313, Crnkovich discloses a rollator that includes four large pneumatic tires, with rear tires larger than the front tires, to facilitate safer movement over rough terrain. As another example, in U.S. Pat. No. 9,173,802, Willis discloses a collapsible wheeled walker with large wheels and a folding mechanism for convenient storage.

Some practitioners propose improving the walker mobility aid by adding upper body support means for supporting the user's forearms, hands or shoulders, to improve user comfort and posture. For example, in U.S. Pat. No. 5,657,783, Sisko et al. disclose accessory forearm rests that may be mounted to any conventional invalid walker, preferably disposed above the normal hand-grips to provide added upper body support.

Such an upright wheeled walker may provide enough upper body support to permit the user to walk upright. For example, in U.S. Pat. No. 8,540,256, Simpson discloses a walker with a forearm support frame to permit an upright user to step forward with the walker footprint. Similarly, in U.S. Pat. No. 8,740,242, Stomp discloses a foldable posterior walker with an anteriorly open frame that permits an upright user to step forward within the walker footprint.

But adding upright support to the wheeled walker introduces the new disadvantages of lateral and longitudinal instability and user safety. Any wheeled walker has longitudinal stability problems when rolling on slopes and over irregular terrain, which may imperil user safety by causing falls during use. This longitudinal instability problem is exacerbated by adding upright support to a wheeled walker because of the increased wheel loads imposed by user upper body weight, which not only increases unwanted longitudinal instability but introduces a new lateral instability arising from the alternating wheel load fluctuations created by user stepping.

Several practitioners suggest improvements to mitigate the wheeled walker longitudinal stability problem with braking system improvements. For example, in U.S. Pat. No. 8,998,223, Chang discloses a wheel braking system for a rollator with a “dead-man brake” whereby the wheels are halted upon the release of the user's hands from the handles, improving user safety on slopes. Similarly, in U.S. Pat. No. 9,221,433, Dunlap discloses a safety braking system for a rollator that includes a park mode, a walk mode and a brake mode with a handlebar control mechanism.

Several practitioners suggest improvements to mitigate the wheeled walker longitudinal stability problem with wheel suspension improvements. A rolling walker may include a spring suspension at each wheel to absorb shocks from rough terrain, thereby improving longitudinal stability. But in an upright wheeled walker, the wheel spring suspension exacerbates the lateral instability arising from the alternating wheel load fluctuations created by user stepping. Hardening or eliminating the suspension springs can reduce lateral instability but only at the expense of increasing longitudinal instability over irregular terrain.

Several practitioners suggest improvements to mitigate lateral or longitudinal rollator stability to increase user safety and prevent falls. For example, in U.S. Pat. No. 8,100,415, Kindberg et al. disclose a wheel suspension for a rollator that facilitates curb climbing. Similarly, in U.S. Pat. No. 5,636,651, Einbinder discloses an adjustable walker controller for stabilizing a wheeled walker by selectively shifting between a mobile and a stable state. But there remains a long-felt unmet need in the art for a suspension that provides both longitudinal and lateral stability in an upright wheeled walker in all states.

These unresolved problems and deficiencies are clearly felt in the art and are solved by this invention in the manner described below.

### SUMMARY OF THE INVENTION

This invention solves the upright wheeled walker stability problem by providing a wheel suspension assembly that, for the first time, suppresses lateral motion from fluctuating wheel load fluctuations created by user stepping while also dampening wheel shocks from irregular terrain. Through a calibrated spring preload adjustment, the wheel suspension assembly of this invention provides lateral stability for any particular user body weight and a wheel deflection working stroke sufficient to absorb wheel shocks over irregular terrain, This wheel suspension assembly is particularly advantageous for upright wheeled walkers.

It is an advantage of the wheel suspension assembly of this invention that a preload adjustment may be made to facilitate customization for any user.

It is a purpose of the wheel suspension assembly of this invention to provide a wheel suspension for wheeled walkers that stabilizes the walker both laterally during user stepping and longitudinally over irregular surfaces when bearing some user body weight.

In one aspect, the invention is a wheel suspension assembly coupled between one of the plurality of wheels and the frame in a wheeled walker having a frame supported above a surface by a plurality of wheels, comprising a preloaded spring restrained by a preload force and disposed to resist displacement of the frame toward the surface and a compressor for changing the preload force.

In another aspect, the invention is a mobility assistance vehicle adapted to support at least some user weight, comprising a frame having a supporting structure adapted to support the user, a plurality of wheels connected to the frame and a shock absorber having a shock absorbing element pre-loaded to a predetermined load limit and disposed between two ends, one shock absorber end being coupled to the frame and the other shock absorber end being coupled to one of the plurality of wheels.

In a preferred embodiment, the invention is an upright wheeled walker comprising a frame and a plurality of wheel assemblies coupled to the frame and disposed to support the frame above a surface; each comprising a wheel and a wheel suspension assembly coupled between the wheel and the frame including a preloaded spring restrained by a preload force and disposed to resist displacement of the frame toward the surface and a compressor for changing the preload force.

The foregoing, together with other objects, features and advantages of this invention, can be better appreciated with reference to the following specification, claims and the accompanying drawing.

### BRIEF DESCRIPTION OF THE DRAWINGS

For a more complete understanding of this invention, reference is now made to the following detailed description of the embodiments as illustrated in the accompanying drawing, in which like reference designations represent like features throughout the several views and wherein:

FIG. 1 is an oblique view of an exemplary upright wheeled walker embodiment with four wheel assemblies illustrating an exemplary embodiments of this invention;

FIG. 2 is a close-up oblique view of the left front wheel assembly embodiment of FIG. 1,

FIG. 3 is a close-up cutaway side view of portion of the wheel assembly embodiment of FIG. 2 illustrating the wheel fork assembly hinge structure;

FIG. 4 is an oblique view of the wheel suspension assembly embodiment of FIG. 2;

FIG. 5 is a side cross-sectional view of the wheel suspension assembly embodiment of FIG. 4;

FIG. 6 is an oblique view of an exemplary (spring) shock absorber embodiment suitable for use with the wheel suspension assembly of this invention;

FIG. 7 is a side cross-sectional view of the shock absorber element embodiment of FIG. 6;

FIG. 8 is an exploded view of the shock absorber embodiment of FIG. 6,

FIG. 9 is a side view of an exemplary embodiment of a preload force setting tool and indicator embodiment suitable for use with the wheel suspension assembly of this invention;

FIG. 10 is a chart illustrating the force vs. displacement characteristic of the shock absorber embodiment of FIG. 6;

FIG. 11 view of an alternative (gas) shock absorber embodiment suitable for use with the wheel suspension assembly embodiment of this invention;

FIG. 12 is a chart illustrating the force vs. displacement characteristic of the shock absorber embodiment of FIGS. 11; and

FIG. 13 is an oblique view of a user standing in a partially supported position with the upright wheeled walker embodiment of FIG. 1.

### DETAILED DESCRIPTION OF THE EMBODIMENTS

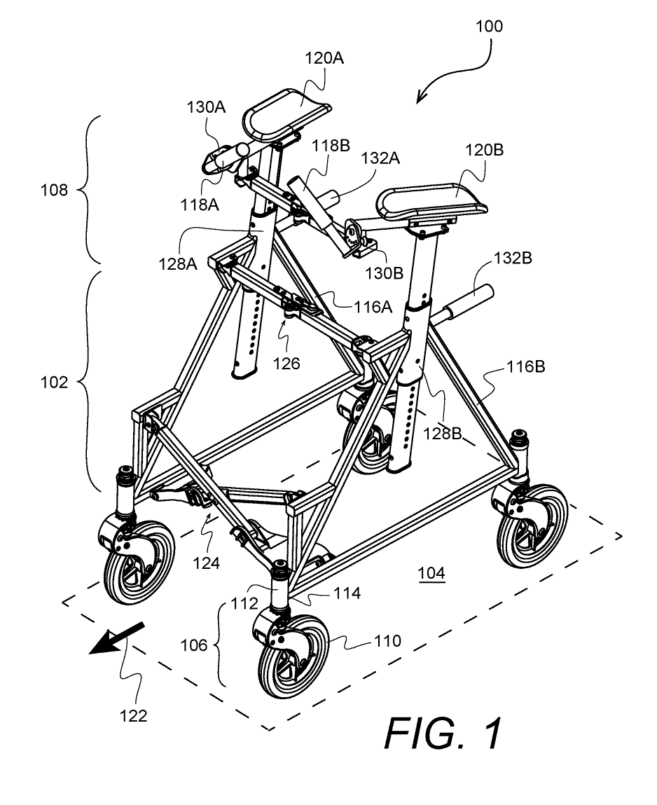

FIG. 1 shows an upright wheeled walker 100 with a frame 102 supported above a surface 104 on four wheel assemblies exemplified by a wheel assembly 106 at the left front corner and with an upper body support assembly 108. Wheel assembly 106 includes a wheel 110 and a wheel suspension assembly 112, which is fixed to frame 102 at a junction 114.

During use, a user (not shown) stands between the two frame elements 116A-13 and grasps each of the upper handles 118A-B with a hand (not shown) while resting a forearm (not shown) in each of the armrest gutters 120A-B, thereby resting at least some weight on upright wheeled walker 100 and surface 104 The user may then walk forward in the direction shown by the arrow 122 as upright wheeled walker 100 rolls over surface 104 while supporting at least some weight, thereby assisting the user to walk over surface 104.

FIG. 1 also illustrates an X-folder element 124 and an upper folder element 126 that are useful for collapsing upright wheeled walker 100 for convenient storage and transportation. The elevation adjusters 128A-B are useful for adjusting the elevation of upper body support assembly 108 above surface 104 for a particular user height and each of the angle adjusters 130A-B are useful for adjusting the angle of the respective upper handle 118A-B. The lower handles 132A-B are useful for several purposes such as providing user support when arising from a seated position (not shown), for example.

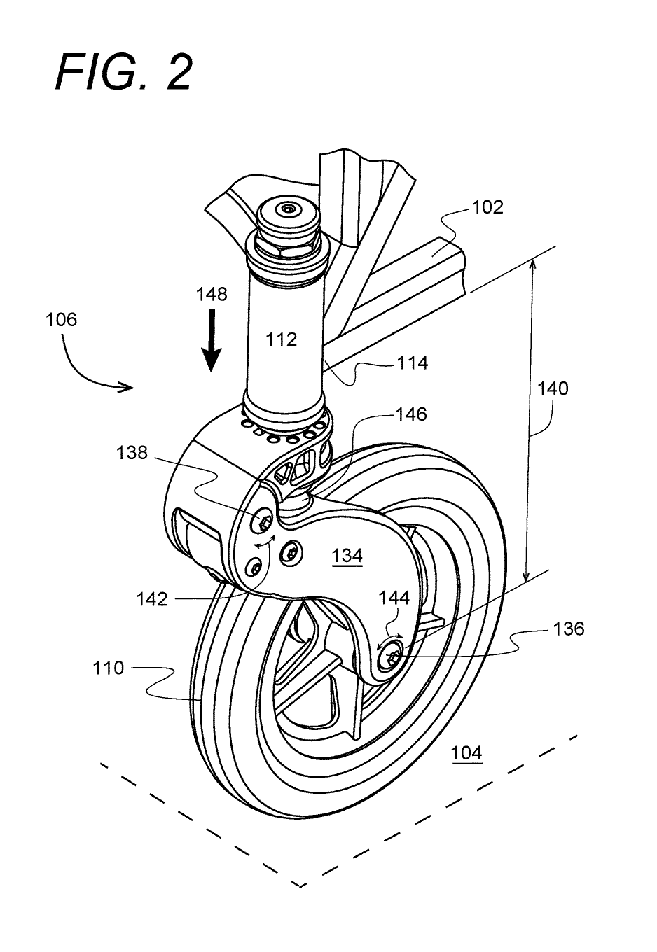

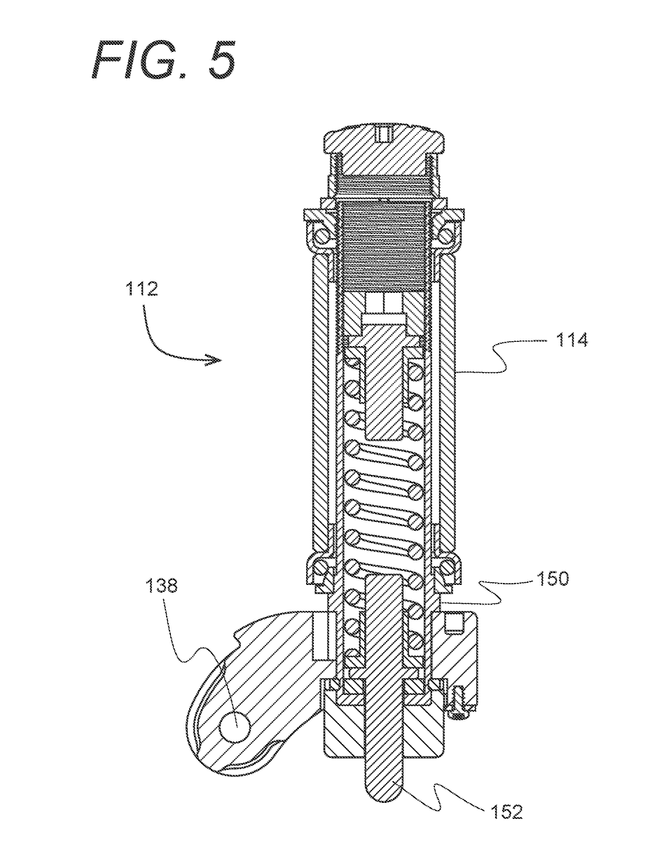

FIG. 2 shows wheel assembly 106 in more detail. A wheel fork assembly 134 is rotatably coupled to wheel 110 at an axle 136 and to wheel suspension assembly 112 at a hinge 138 thereby permitting displacement of frame 102 with respect to surface 104 responsive to any rotation of wheel fork assembly 134 at hinge 138 and axle 136. Any rotation of wheel fork assembly 134 changes the elevation 140 of frame 102 above axle 136 as can be appreciated with reference to the arrows 142 and 144 in FIG. 2. Wheel suspension assembly 112 is also in contact with wheel fork assembly 134 at the support 146 and controls elevation 140 responsive to the downward force 148 imposed on wheel assembly 106 in the manner that is described below in connection with FIGS. 5-12.

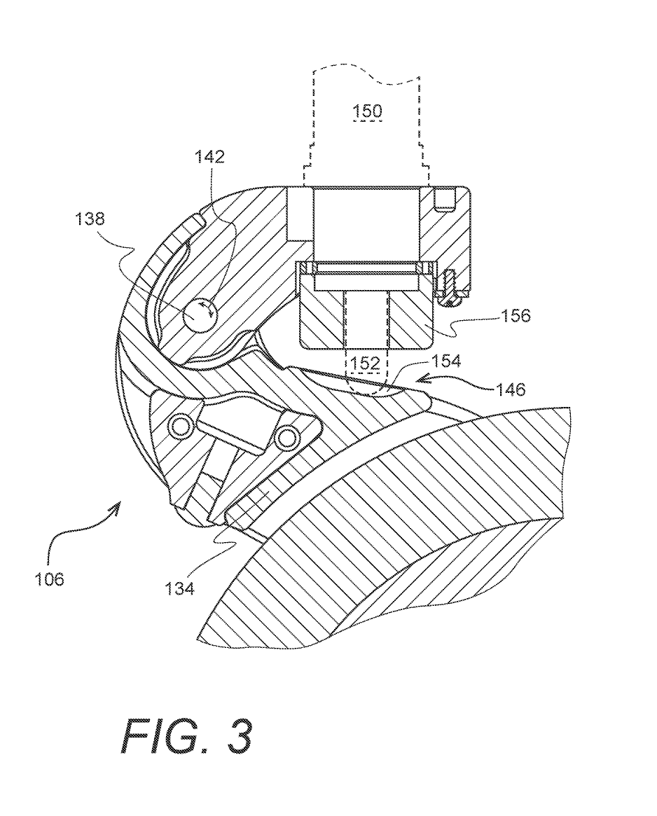

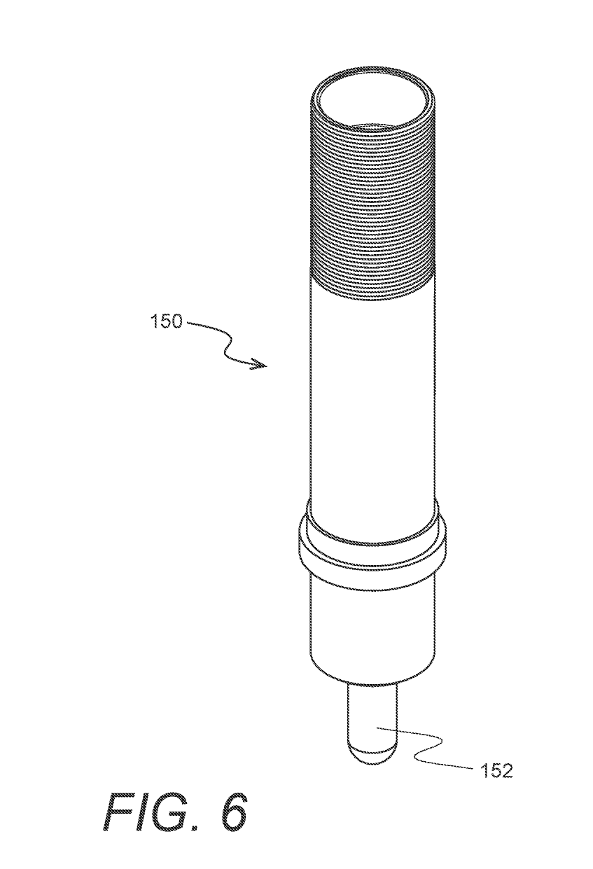

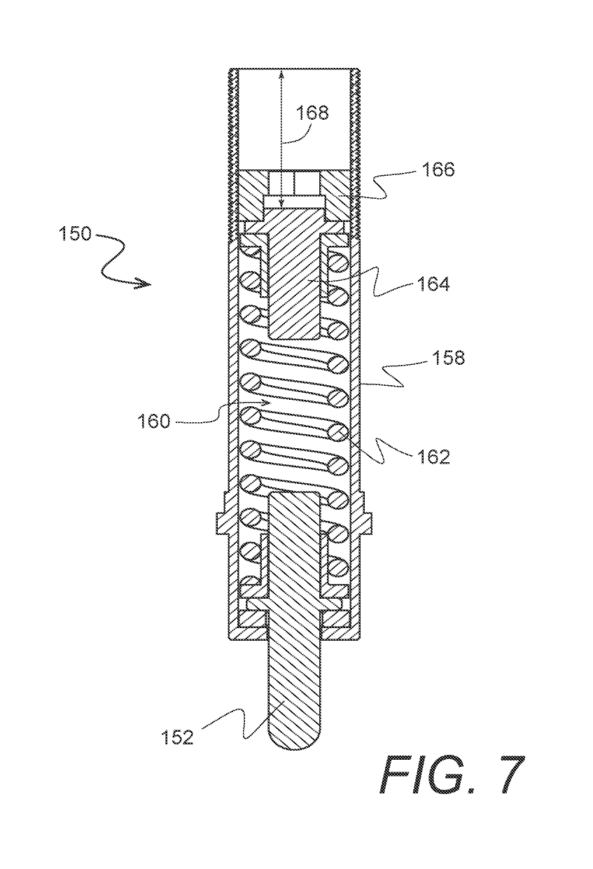

FIG. 3 shows a cutaway side view of wheel assembly 106 illustrating the wheel fork assembly hinge 138 and the lower portion of wheel suspension assembly 112 with the shock absorber 150 (FIGS. 6-7) removed (dotted lines) for clarity. The absent lower pin 152 (dotted lines) of shock absorber 150 (FIGS. 6-7) normally rests against a cavity 154 in wheel fork assembly 134 substantially as illustrated. A snubbing spacer 156 of any suitable material known in the art is shown disposed to limit the rotation about hinge 138 and avoid metal-on-metal contact from larger shocks.

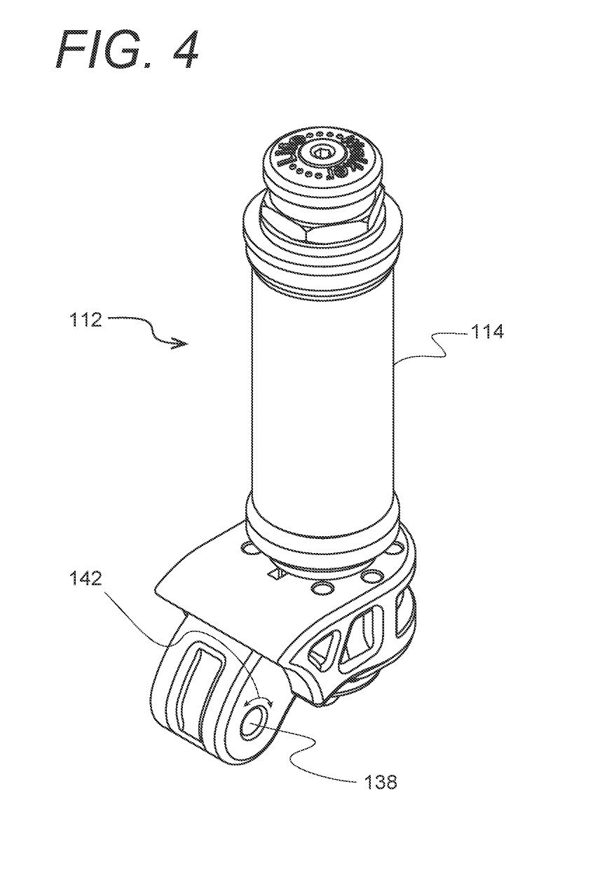

Wheel suspension assembly 112 is shown in FIG. 4 in an oblique view and in FIG. 5 as a cross-sectional side view showing lower pin 152 and hinge 138. FIG. 6 shows shock absorber 150 in an oblique view as it appears when removed from wheel suspension assembly 112. FIG. 7 shows shock absorber 150 in a cross-sectional side view, which is now described.

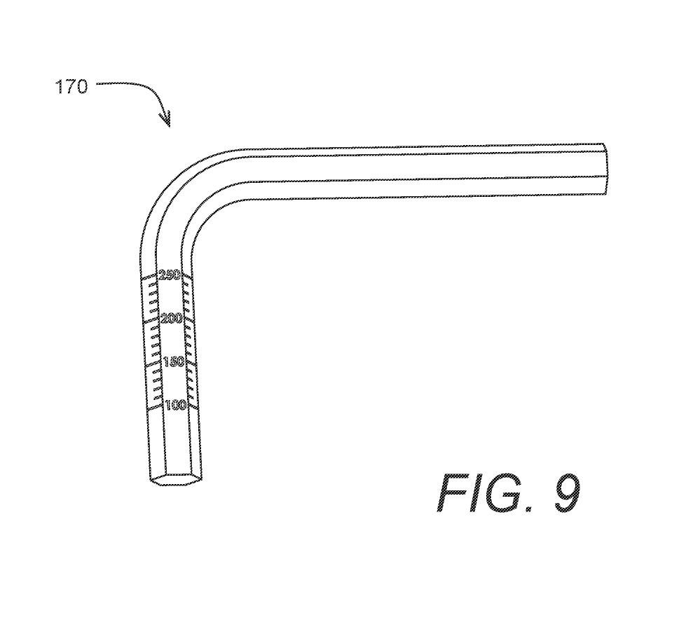

In FIG. 7, shock absorber 150 includes the outer housing 158 that houses a preloaded spring 160 embodiment that contains the coil spring 162, which is compressed and restrained by the preload force created between lower pin 152 and the upper pin 164 when the spring compressor 166 embodied as a cap screw is threaded into outer housing 158. Coil spring 162 may be embodied as, for example, a constant pitch column spring characterized by a constant spring coefficient or as a conical spring, or an hourglass spring, or a barrel-shaped spring, or any useful spring providing a variable spring coefficient over a varying suppression distance, for example. In shock absorber 150 the preload force can be changed by threading spring compressor 166 along inside outer housing 158 to adjust the distance 168, which may be measured with a calibrated preload force setting indicator such as the scaled hex wrench embodiment 170 illustrated in FIG. 9, for example, to determine the preload force imposed on preloaded spring 160.

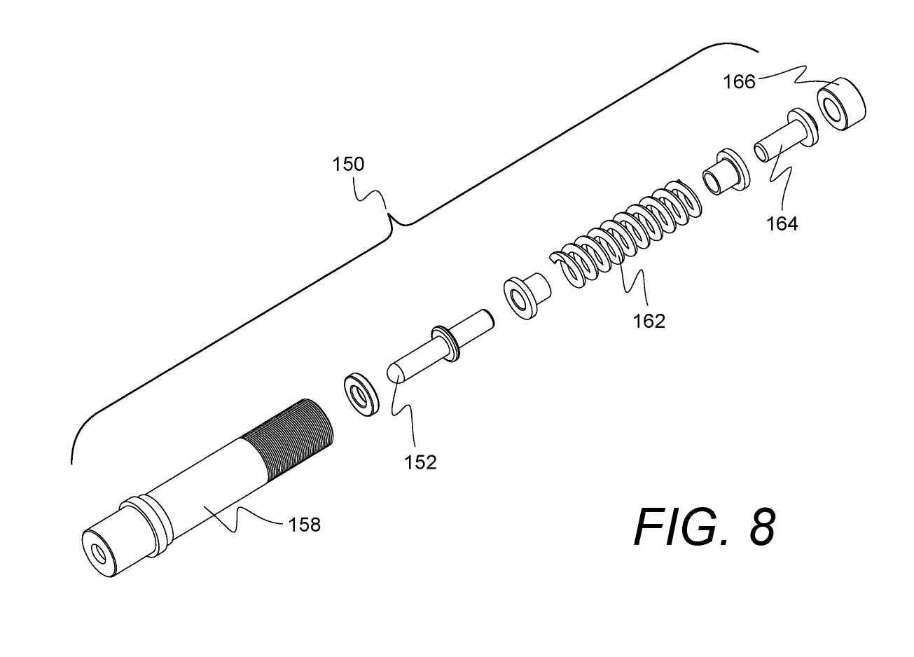

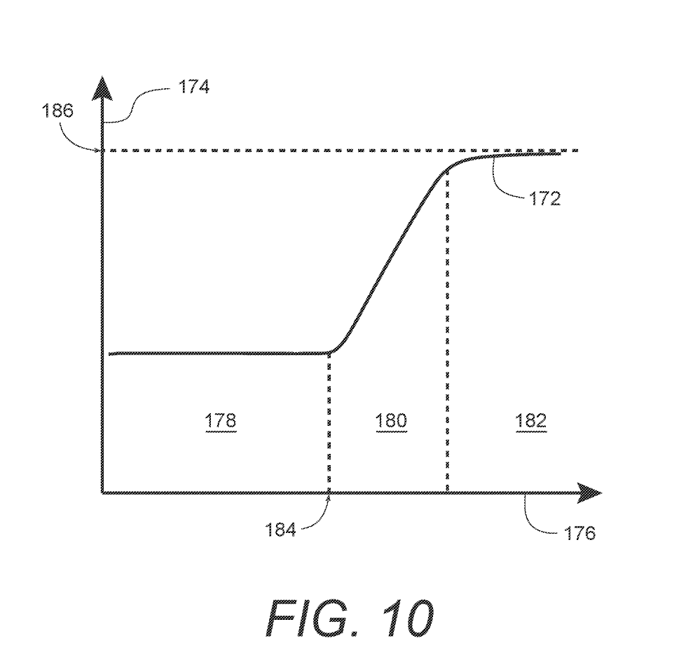

FIG. 8 shows an exploded view of the elements of shock absorber 150 to illustrate more clearly the relationship among outer housing 158, lower pin 152, coil spring 162, upper pin 164, and spring compressor 166. Coil spring 162 is selected with the length and spring constant necessary for imposing the preload force desired when assembled. According to the teachings of this invention, this preload force must be selected to simultaneously absorb wheel shocks while rolling over uneven terrain and support the user body weight resting on the wheeled walker wheels without reducing elevation 140 (FIG. 2) of frame 102 beyond a predetermined amount. Wheel suspension assembly 106 accomplishes this with shock absorber 150 in the manner that may be appreciated with reference to FIG. 10.

FIG. 10 is a curve 172 illustrating the relationship between the displacement (along the vertical axis 174) of frame elevation 140 (FIG. 2) and the force imposed on wheel suspension assembly 106 (along the horizontal axis 176) for shock absorber 150 of FIG. 7. FIG. 10 is not to scale and certain regions are emphasized to better illustrate the features of this invention. Curve 172 has three regions demarked with dotted lines and labeled as a stability region 178, a shock absorbing region 180 and a snubbing region 182. Within stability region 178, upright wheeled walker 100 (FIG. 1) will remain at a fixed elevation above surface 104 (FIGS. 1-2) for any imposed downward force between zero and a predetermined adjustable force 184, which may be adjusted by adjusting compressor 166 (FIGS. 7-8) using, for example, scaled hex wrench 170 (FIG. 9) as a calibrated preload force indicator. Within shock absorbing region 180, which is a linear region for the constant pitch column spring embodiment of coil spring 162 illustrated in FIGS. 7-8 (force rises linearly with displacement), shock absorber 150 operates to absorb wheel shocks while rolling over uneven terrain. In snubbing region 182, wheel suspension assembly 112 (FIG. 3) has bottomed out against snubbing spacer 156 (FIG. 3) at a maximum design displacement 186 and no additional displacement is possible.

In a preferred embodiment, when a user rests on wheeled walker 100 with her arms on armrest gutters 120A-B, wheeled walker 100 carries some user weight and gives her support for better mobility. Preferably coil spring 162 is preloaded by compressor 166 according to the user's weight and her support preference, in such a manner that the user's supported weight alone permits shock absorber 150 to operate in stability region 178. This means that the amount of force exerted on shock absorber 150 by the supported user through armrest gutters 120A-B is less than the spring preload force created by compressor 166. Accordingly, there is no walker elevation change under the supported weight and the user enjoys a stable ride.

However, when wheel 110 encounters and rolls over uneven terrain, such as a rock or an edge, for example, a shock force is received by wheel 110 transferred to shock absorber 150 through wheel fork 134 and lower pin 152. According to the purpose of this invention, the spring preload force is predetermined to be less than the shock force magnitude created by rolling over uneven terrain. Accordingly, when shock absorber 150 operates in shock absorbing region 180, any shock force exceeding the predetermined preload force is absorbed by compression of coil spring 162, thereby maintaining longitudinal stability and cushioning the user from unpleasant bumps and jars when rolling over uneven terrain. The predetermined spring preload force is preferably established according to the user's weight, which creates a known correlation between the distance 168 (FIG. 7) and the user's weight. Thus, hex wrench embodiment 170 may be, for example, scaled with various user weights in pounds as shown in FIG. 9, for convenient calibration of the preload force established in shock absorber 150 according the user's weight.

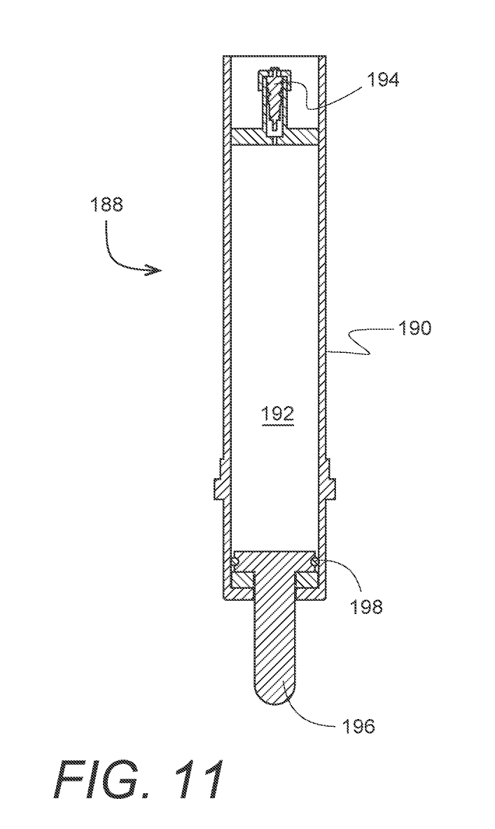

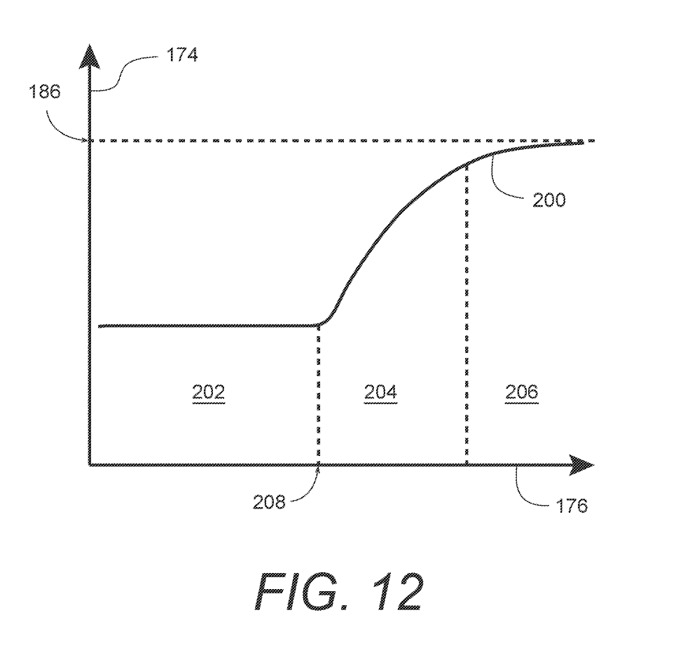

FIG. 11 shows an alternative shock absorber embodiment 188 suitable for use with the wheel suspension assembly of this invention. Shock absorber 188 includes an outer housing 190 containing a gas pressure chamber 192 that embodies a preloaded spring.. The upper valve core 194 embodies a compressor means to change the gas pressure in chamber 192, thereby providing an adjustable preload force on the lower pin 196, which is slidably engaged with gas pressure chamber 192 and sealed with a gas seal 198 to prevent loss of preloaded chamber pressure. Any useful gas pressure gage (not shown) may be used as a preload force setting indicator to measure gas pressure in chamber 192 whereby the preload force restraining lower pin 196 can be adjusted by varying the gas pressure in chamber 192 to a desired value. Shock absorber 188 is suitable for use with the wheel suspension assembly of this invention as may be appreciated with reference to FIG. 12.

FIG. 12 is a curve 200 illustrating the relationship between the displacement (along the vertical axis 174) of frame elevation 140 (FIG. 2) and the force imposed on wheel suspension assembly 106 (along the horizontal axis 176). FIG. 12 is not to scale and certain regions are emphasized to better illustrate the features of this invention. Curve 200 has three regions demarked with dotted lines and labeled as a stability region 202, a shock absorbing region 204 and a snubbing region 206. Within stability region 202, upright wheeled walker 100 (FIG. 1) will remain at a fixed elevation above surface 104 (FIGS. 1-2) for any imposed downward force between zero and a predetermined adjustable force 208, which may be adjusted by adding or releasing gas from gas pressure chamber 192 through the upper valve core 194 (FIG. 11) using, for example, any useful gas compressor and pressure gage known in the art (not shown) as a calibrated preload force indicator. Within shock absorbing region 204, which is an inverse region (force rises linearly with pressure which rises as the reciprocal of volume), shock absorber 188 operates to absorb wheel shocks while rolling over uneven terrain. In snubbing region 206, wheel suspension assembly 112 (FIG. 3) has bottomed out against snubbing spacer 156 (FIG. 3) at a maximum design displacement 186 and no additional displacement is possible. Unlike coil spring 152 (FIGS. 7-8), gas pressure chamber 192 will not “bottom out” internally.

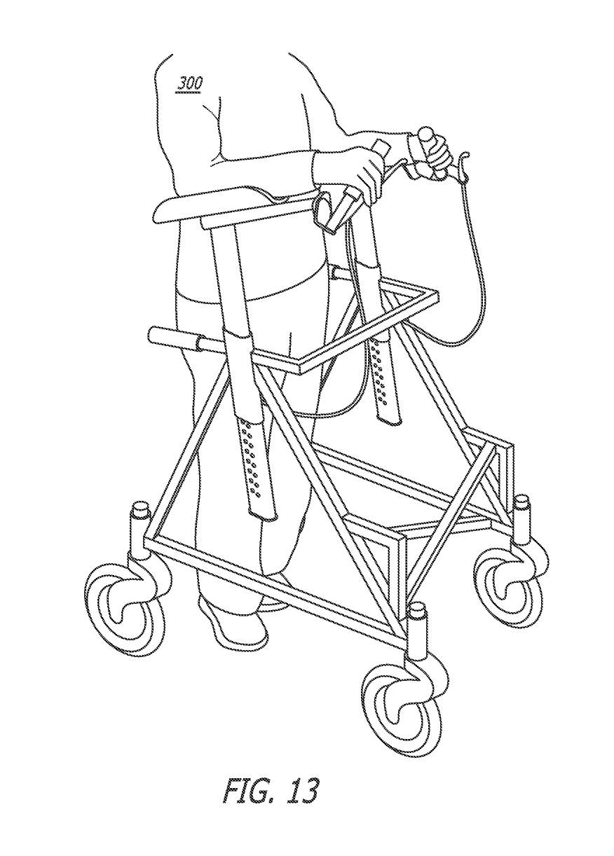

FIG. 13 illustrates a user 300 standing with upright wheeled walker 100 and illustrates the proper disposition of user forearms and hands when using upright wheeled walker 100 for support while walking along a surface substantially as described above.

Clearly, other embodiments and modifications of this invention may occur readily to those of ordinary skill in the art in view of these teachings. Therefore, this invention is to be limited only by the following claims, which include all such embodiments and modifications when viewed in conjunction with the above specification and accompanying drawing.

1. In a wheeled walker having a frame supported above a surface by a plurality of wheels, a wheel suspension assembly coupled between one of the plurality of wheels and the frame, comprising:
a preloaded spring restrained by a preload force and disposed to resist displacement of the frame toward the surface; and
a compressor for changing the preload force.

2. The assembly of claim 1 wherein
the compressor includes a threaded screw.

3. The assembly of claim 2 wherein
the compressor includes a preload force setting indicator.

4. The assembly of claim 1 further comprising:
a snubbing spacer disposed to prevent displacement of the frame closer to the surface than a predetermined distance.

5. assembly of claim 1 wherein
the preloaded swing includes a compressed air gap.

6. A wheeled walker for assisting a user having one or more forearms, the walker comprising:
a frame; and
a plurality of wheel assemblies coupled to the frame and disposed to support the frame above a surface; each comprising
a wheel, and
a wheel suspension assembly coupled between the wheel and the frame and including
a preloaded spring restrained by a preload force and disposed to resist displacement of the frame toward the surface, and
a compressor for changing the preload force.

7. The wheeled walker of claim 6 further comprising:
an upper body support assembly coupled to the frame and disposed to support the one or more user forearms.

8. The upright wheeled walker of claim 7 wherein
the compressor in each wheel assembly includes a threaded screw.

9. The upright wheeled walker of claim 8 wherein
the compressor in each wheel assembly includes a preload force setting indicator

10. The upright wheeled walker of claim 7 further comprising:
a snubbing spacer disposed to prevent displacement of the frame closer to the surface than a predetermined distance.

11. The upright wheeled walker of claim 7 wherein
the preloaded spring includes a compressed air gap.

12. The wheeled walker of claim 6 wherein
the compressor in each wheel assembly includes a threaded screw.

13. The wheeled walker of claim 12 herein
the compressor in each wheel assembly includes a preload force setting indicator.

14. The wheeled walker of claim 6 further comprising:
a snubbing spacer disposed to prevent displacement of the frame closer to the surface than a predetermined distance.

15. The wheeled walker of claim 6 wherein
the preloaded spring in each wheel assembly includes a coil spring.

16. A mobility assistance vehicle adapted to support at east some user weight, comprising:
a frame having a supporting structure adapted to support the user;
a plurality of wheels connected to the frame; and
a shock absorber having a shock absorbing element disposed between two ends, one shock absorber end being coupled to the frame and the other shock absorber end being coupled to one of the plurality of wheels, and the shock absorber being pre-loaded to a predetermined load limit.

17. The mobility assistance vehicle of claim 16 wherein
the shock absorbing element is a compression spring.

18. The mobility assistance vehicle of claim 17 wherein
the predetermined load limit is achieved by suppressing the compression spring by a predetermined distance.

19. The mobility assistance vehicle of claim 16 wherein
the shock absorbing element is a compressed air gap.

20. The mobility assistance vehicle of claim 16 wherein
the predetermined load limit is selected according to the user's weight.
